(19) United States
(12) Patent Application Publication
(10) Pub. No.: US 2020/0020191 A1
(43) Pub. Date: Jan. 16, 2020

(54) PAPER SHEET PROCESSING DEVICE

(71) Applicant: LAUREL PRECISION MACHINES CO., LTD., Osaka (JP)

(72) Inventors: Hitoshi TAKAHASHI, Kawasaki-shi (JP); Naoya UENOMACHI, Niiza-shi (JP); Masashi OBA, Oyama-shi (JP)

(21) Appl. No.: 16/582,220

(22) Filed: Sep. 25, 2019

Related U.S. Application Data
(63) Continuation of application No. PCT/JP2018/011384, filed on Mar. 22, 2018.

(30) Foreign Application Priority Data
Mar. 30, 2017 (JP) 2017-067303

(51) Int. Cl. G07D 11/50; G07D 7/12; G07D 9/04; G07D 11/16; G07D 11/225; G07D 11/40; B65H 7/06; B65H 43/04

(52) U.S. Cl. CPC G07D 11/50; G07D 7/12; G07D 9/04; G07D 11/16; B65H 2701/1912; G07D 11/40; B65H 7/06; B65H 43/04; G07D 11/225

(57) ABSTRACT

A paper sheet processing device includes: a receiving part which opens to an exterior of the device, in which paper sheets from the exterior of the device are set, and which dispenses the set paper sheets in a stacked state, one by one; a conveyance unit which conveys the paper sheets dispensed from the receiving part; an identification unit which identifies whether the paper sheets that are being conveyed by the conveyance unit are a to-be-counted paper sheet or a reject paper sheet; a post-count accumulating part which accumulates a paper sheet identified as the to-be-counted paper sheet; and a plurality of reject accumulating parts which accumulate, in a state sorted by reason for rejection, a paper sheet identified as the reject paper sheet.

### CROSS-REFERENCE TO RELATED APPLICATIONS

The present application is a continuation application of International Application No. PCT/JP2018/011384, filed Mar. 22, 2018, which claims priority to Japanese Patent Application No. 2017-067303, filed Mar. 30, 2017. The contents of these applications are incorporated herein by reference.

### BACKGROUND OF THE INVENTION

### Field of the Invention

The present invention relates to a paper sheet processing device.

### Description of Related Art

Paper sheet processing devices for processing paper sheets have previously been proposed (see, for example, Japanese Unexamined Patent Application, First Publication No. 2015-41134). A paper sheet processing device takes one by one into the device paper sheets charged in a stacked state into a receiving part, and identifies the paper sheets that have been dispensed from the receiving part with an identification unit provided on a conveyance path for conveying the paper sheets. Furthermore, the paper sheet processing device uses the conveyance path to sort the paper sheets according to the types identified by the identification unit, and stores the paper sheets in a plurality of accumulating units that are removable to the outside.

### SUMMARY OF INVENTION

The paper sheet processing device as described above has one reject accumulating unit in addition to the accumulating unit. The accumulating unit is configured to store the paper sheets identified as to-be-counted paper sheets on the basis of the identification result of the identification unit. The reject accumulating unit is configured to store, for example, paper sheets identified as reject paper sheets such as unidentifiable paper sheets that cannot be identified or double-fed paper sheets and the like. For this reason, paper sheets identified as reject paper sheets are uniformly stored in one reject accumulating unit even if the reasons for rejection differ. As a result, there is a possibility that the efficiency of the processing of the paper sheets may be reduced.

Therefore, an object of the present invention is to provide a paper sheet processing device capable of improving the processing efficiency of paper sheets.

In order to achieve the above object, a paper sheet processing device according to an aspect of the present invention includes: a receiving part which opens to an exterior of the device, in which paper sheets from the exterior of the device are set, and which dispenses the set paper sheets in a stacked state, one by one; a conveyance unit which conveys the paper sheets dispensed from the receiving part; an identification unit which identifies whether the paper sheets that are being conveyed by the conveyance unit are a to-be-counted paper sheet or a reject paper sheet; a post-count accumulating part which accumulates a paper sheet identified as the to-be-counted paper sheet; and a plurality of reject accumulating parts which accumulate, in a state sorted by reason for rejection, a paper sheet identified as the reject paper sheet.

According to the present invention, it is possible to provide a paper sheet processing device capable of improving the processing efficiency of paper sheets.

### BRIEF DESCRIPTION OF THE DRAWINGS

FIG. 1 is a schematic configuration view of a paper sheet processing device according to a first embodiment of the present invention as viewed from the front side.

FIG. 2 is a schematic configuration view from the front side showing the state of the receiving part of the paper sheet processing device pulled out and the conveyance unit opened up.

FIG. 3 is a schematic configuration view from the front side showing a modification of the state of the receiving part of the paper sheet processing device pulled out and the conveyance unit opened up.

FIG. 4 is a schematic configuration view from the front side showing another modification of the state of the receiving part of the paper sheet processing device pulled out and the conveyance unit opened up.

FIG. 5 is a flowchart of the sorting process of the first operation mode of the paper sheet processing device shown in FIG. 1.

FIG. 6 is a flowchart of the sorting process of the second operation mode of the paper sheet processing device shown in FIG. 1.

FIG. 7 is a schematic configuration view of a paper sheet processing device according to a second embodiment of the present invention as viewed from the front side.

FIG. 8 is a flowchart of the sorting process of the paper sheet processing device shown in FIG. 7.

FIG. 9 is a schematic configuration view of a paper sheet processing device according to a third embodiment of the present invention as viewed from the front side.

### EMBODIMENTS FOR CARRYING OUT THE INVENTION

### First Embodiment

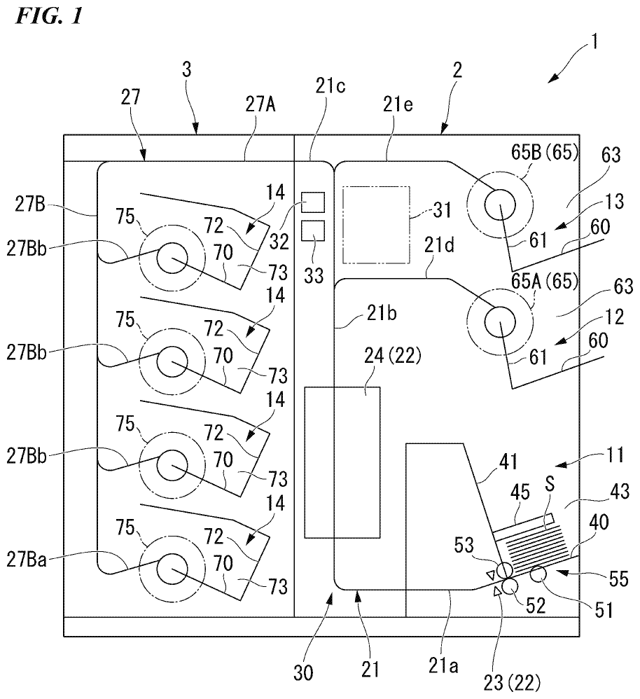

A paper sheet processing device according to a first embodiment of the present invention will be described below with reference to FIGS. 1 to 6.

The paper sheet processing device 1 according to the present embodiment shown in FIG. 1 performs a process of mainly sorting banknotes as paper sheets S. For example, the paper sheet processing device 1 sorts the paper sheets S that have been charged into to-be-counted paper sheets which are to be counted and reject paper sheets which are not to be counted. Moreover, the paper sheet processing device 1 further counts by type and accumulates by type the to-be-counted paper sheets and displays the counting result and accumulating destination in association with each other. In the following description, “front” means the operator side. “Rear” means the opposite side to the operator. “Right” means the right side as viewed from the operator. “Left” means the left side as viewed from the operator.

As shown in FIG. 1, the paper sheet processing device 1 according to the first embodiment is configured by combining a base unit 2 and a sorting-accumulating unit 3 as a processing unit.

The base unit 2 has a receiving part 11, a lower reject accumulating part 12 (accumulating part, reject accumulating part, reject provisional accumulating part), and an upper reject accumulating part 13 (accumulating part, reject accumulating part, reject final accumulating part). The receiving part 11 is provided at the lower part of the right side surface, and is always open to outside the base unit 2, that is, outside the paper sheet processing device 1, across the right side surface and the front surface. The lower reject accumulating part 12 is provided at the middle in the vertical direction on the right side surface similarly to the receiving part 11 and is always open to outside the base unit 2, that is, outside the paper sheet processing device 1 across the right side surface and the front surface. The upper reject accumulating part 13 is provided at the upper part on the right side surface similarly to the receiving part 11 and the lower reject accumulating part 12 and is always open to outside the base unit 2, that is, outside the paper sheet processing device 1 across the right side and the front. The receiving part 11, the lower reject accumulating part 12, and the upper reject accumulating part 13 are arranged side by side from the bottom to top with the positions thereof overlapping in the front-rear direction and left-right direction.

A plurality of the paper sheets S are set in the receiving part 11 so as to be vertically stacked with the long side aligned with the front-rear direction and the short side aligned with the left-right direction. The receiving part 11 one by one separates and dispenses the stacked paper sheets S set in this way from the lowermost paper sheet, with the paper sheets S thereby being taken into the paper sheet processing device 1. The paper sheets S dispensed from the receiving part 11 moves along the extension direction of the short side thereof.

An in-base unit conveyance constituent unit 21 and an identification unit 22 are provided inside the base unit 2. The in-base unit conveyance constituent unit 21 conveys the paper sheets S dispensed from the receiving part 11. The identification unit 22 counts and identifies the paper sheets S being conveyed by the in-base unit conveyance constituent unit 21. The paper sheets S conveyed by the in-base unit conveyance constituent unit 21 move along the extension direction of the short side. The identification unit 22 includes a detection unit 23 and an identification main body unit 24. The detection unit 23 is provided at an end position on the receiving part 11 side of the in-base unit conveyance constituent unit 21 and detects a conveyance state of the paper sheet S dispensed by the receiving part 11. The identification main body unit 24 is provided downstream of the detection unit 23 of the in-base unit conveyance constituent unit 21 and identifies types such as denomination other than the conveyance state of the paper sheet S.

The in-base unit conveyance constituent unit 21 has a leftward extension part 21a, an upward extension part 21b, and a leftward extension part 21c. The leftward extension part 21a extends from the receiving part 11 toward the left side surface of the base unit 2. The upward extension part 21b extends upward from the end near the left side surface of the leftward extension part 21a. The leftward extension part 21c extends from the upper end of the upward extension part 21b to the left side surface of the base unit 2 and opens to the left side surface. In the in-base unit conveyance constituent unit 21, the identification unit 22 is provided in the upward extension part 21b along the vertical direction.

The in-base unit conveyance constituent unit 21 further includes a branch extension part 21d and a branch extension part 21e. The branch extension part 21d branches from the upward extension part 21b at a position above the identification unit 22, extends toward the right side surface of the base unit 2, and is connected to the lower reject accumulating part 12. The branch extension part 21e branches from the upper end of the upward extension part 21b above the branch extension part 21d, extends toward the right side surface of the base unit 2, and is connected to the upper reject accumulating part 13.

An in-sorting-accumulating unit conveyance constituent unit 27 (in-processing unit conveyance constituent unit) that is connected to the leftward extension part 21c of the base unit 2 and that conveys paper sheets S dispensed from the leftward extension part 21c is provided in the sorting-accumulating unit 3. As in the case of the base unit 2, the paper sheets S conveyed by the in-sorting-accumulating unit conveyance constituent unit 27 also move along the extension direction of the short side thereof.

The in-sorting-accumulating unit conveyance constituent unit 27 includes a coupling conveyance constituent unit 27A and a branching conveyance constituent unit 27B. The coupling conveyance constituent unit 27A opens to the upper part of the right side surface of the sorting-accumulating unit 3, extends horizontally and linearly toward the left side surface of the sorting-accumulating unit 3, and opens to the upper part of the left side surface. The branching conveyance constituent unit 27B branches downward from the left side portion of the coupling conveyance constituent unit 27A. The coupling conveyance constituent unit 27A and the branching conveyance constituent unit 27B each have separate drive motors, and can be driven independently.

The branching conveyance constituent unit 27B includes a downward extension part 27Ba and three branch extensions 27Bb. The downward extension part 27Ba is branched from the left side portion of the coupling conveyance constituent unit 27A and extends vertically downward. The end of the downward extension part 27Ba located opposite the coupling conveyance constituent unit 27A extends toward the right side surface of the sorting-accumulating unit 3. The plurality of branch extensions 27Bb branch from the middle position of the downward extension part 27Ba and extend toward the right side surface of the sorting-accumulating unit 3. A post-count accumulating part 14 (accumulating part) is connected to each of the end of the downward extension part 27Ba and the three branch extensions 27Bb. Therefore, multiple (specifically, four) post-count accumulating parts 14 are provided in the sorting-accumulating unit 3. The post-count accumulating parts 14 are always open from the front surface of the sorting-accumulating unit 3 to the outside of the sorting-accumulating unit 3, that is, the outside of the paper sheet processing device 1.

The plurality of post-count accumulating parts 14 are arranged side by side from the top to the bottom with the positions thereof overlapping in the front-rear direction and the left-right direction. The plurality of post-count accumulating parts 14 also overlap the positions in the front-rear direction of the receiving part 11, the lower reject accumulating part 12, and the upper reject accumulating part 13 provided in the base unit 2.

The conveyance unit 30 has the in-base unit conveyance constituent unit 21 and the in-sorting-accumulating unit conveyance constituent unit 27 that are mutually connected. The conveyance unit 30 conveys the paper sheets S dispensed from the receiving part 11. The paper sheets S are identified by the identification unit 22 while being conveyed by the conveyance unit 30. On the basis of the identification result of the identification unit 22, the conveyance unit 20, with regard to portions downstream of the identification unit 22, distributes the paper sheets S alternatively to one of the lower reject accumulating part 12, the upper reject accumulating part 13, and the plurality of post-count accumulating parts 14.

In the paper sheet processing device 1, the lower reject accumulating part 12, the upper reject accumulating part 13, and the plurality of post-count accumulating parts 14 accumulate the paper sheets S classified on the basis of the identification result of the identification unit 22 so as to be removable to outside the paper sheet processing device 1.

Among the paper sheets S taken into the paper sheet processing device 1 at the receiving part 11, the lower reject accumulating part 12 and the upper reject accumulating part 13 stack the paper sheets S identified as reject paper sheets by the identification unit 22 and accumulate the paper sheets S in a manner to be removable to outside the paper sheet processing device 1. The reject paper sheets include, for example, paper sheets that have not been identified as to-be-counted paper sheets by the identification unit 22. The paper sheets S are dispensed from the in-base unit conveyance constituent unit 21. Both the lower reject accumulating part 12 and the upper reject accumulating part 13 stack the paper sheets S dispensed from the in-base unit conveyance constituent unit 21 from the bottom to the top in the delivery order (in other words, the order of being taken in at the receiving part 11). The paper sheets S, upon being dispensed from the branch extension part 21d of the in-base unit conveyance constituent unit 21 to the lower reject accumulating part 12, are stacked from bottom to top in the lower reject accumulating part 12 with the long side aligned along the front and rear and the short side aligned along the left and right. In addition, the paper sheets S, upon being dispensed from the branch extension part 21e of the in-base unit conveyance constituent unit 21 to the upper reject accumulating part 13, are stacked from bottom to top in the upper reject accumulating part 13 with the long side aligned along the front and rear and the short side aligned along the left and right. The plurality of reject accumulating parts, specifically, the lower reject accumulating part 12 and the upper reject accumulating part 13, accumulate the paper sheets S that have been identified as reject paper sheets by the identification unit 22 and sorted by reason for rejection.

Among the paper sheets S taken into the paper sheet processing device 1 by the receiving part 11, the plurality of post-count accumulating parts 14 stack by type the paper sheets S identified as to-be-counted paper sheets by the identification unit 22 and counted by type and accumulate the stacked paper sheets S so as to be removable to outside the paper sheet processing device 1. Each of the plurality of post-count accumulating parts 14 stacks the paper sheets S dispensed from the in-sorting-accumulating unit conveyance constituent unit 27 from the right to the left in the delivery order (in other words, the order of being taken in at the receiving part 11).

An operation display unit 31 that receives operation inputs and displays information is provided in the front surface of the base unit 2 of the paper sheet processing device 1. A control unit 32 and a storage unit 33 are provided in the base unit 2. The control unit 32 controls the base unit 2 and each part of the sorting-accumulating unit 3 coupled to the base unit 2. The storage unit 33 stores data such as master data serving as a reference for identification, identification and counting results, and the like.

As described above, the receiving part 11 provided in the base unit 2 is provided on the right side surface of the paper sheet processing device 1 so as to always open to the right side and to the front. The receiving part 11 has a bottom part 40, a wall part 41 and a wall part 43. The bottom part 40 is disposed so as to be inclined slightly downward to the left with respect to the horizontal. The wall part 41 extends upward from the left end position of the bottom part 40 perpendicularly to the bottom part 40. The wall part 43 extends vertically upward from the rear end edge of the bottom part 40. The bottom part 40 and the wall part 41 extend in the front-rear direction. The wall part 43 extends in the vertical direction and in the left and right direction. The bottom part 40, the wall part 41 and the wall part 43 are arranged perpendicularly to one another. In the receiving part 11, the paper sheets S are set in a stacked state on the bottom part 40 so that one long side is in contact with the wall part 41 and one short side is in contact with the wall part 43. The receiving part 11 has a bill press 45 that is provided above the bottom part 40 and that moves up and down along the wall part 41. The bill press 45 presses the paper sheets S placed on the bottom part 40 toward the bottom part 40.

The receiving part 11 has a kick-out roller 51, a take-in roller 52, and a separation roller 53. The kick-out roller 51 kicks out the lowermost paper sheet S of the paper sheets S set on the bottom part 40 toward the in-base unit conveyance constituent unit 21 to the left. The take-in roller 52 takes in the paper sheet S kicked out by the kick-out roller 51 into the paper sheet processing device 1 and delivers the paper sheet S to the in-base unit conveyance constituent unit 21. The separation roller 53 separates the paper sheets S taken in by the take-in roller 52 one by one. The kick-out roller 51, the take-in roller 52, and the separation roller 53 constitute a take-in unit 55 that one by one separates the paper sheets S set in the receiving part 11 and takes the separated paper sheets S into the paper sheet processing device 1.

The detection unit 23 of the identification unit 22 described above is disposed at a position near the receiving part 11 in the leftward extension part 21a of the in-base unit conveyance constituent unit 21. The detection unit 23 detects whether the paper sheet S has been dispensed from the receiving part 11 and detects the conveyance state of the paper sheet S. The detection unit 23 detects the presence or absence of double feeding from the light transmittance or physical thickness of the paper sheet S. The detection unit 23 detects the presence or absence of skewing from a deviation in the detected timings of both sides of the paper sheet S in the long side direction. The detection unit 23 detects the presence or absence of near feed from the interval between detected timings of adjacent paper sheets S. A paper sheet S in which none of double feed, skew and near feed has been detected by the detection unit 23 is, in other words, a paper sheet S that has been detected by the detection unit 23 as being normally conveyed.

The identification main body unit 24 of the identification unit 22 detects images of the paper sheet S during visible light irradiation and during ultraviolet light irradiation, and compares each with reference data. The identification main body unit 24 specifies the type of reference data that can determine the detected image as a match as the type of the paper sheet S. The paper sheet S whose type is specified in this manner is the paper sheet S with no identification error. On the other hand, when there is no reference data that can determine the detected image as a match, the identification main body unit 24 identifies the paper sheet S as one with an identification abnormality.

The lower reject accumulating part 12 and the upper reject accumulating part 13 provided in the base unit 2 have the same configuration. Each of the lower reject accumulating part 12 and the upper reject accumulating part 13 has a bottom part 60, a wall part 61 and a wall part 63. The bottom part 60 is disposed to be inclined slightly downward to the left with respect to the horizontal. The wall part 61 extends upward from the left end position of the bottom part 60 substantially perpendicularly to the bottom part 60. The wall part 63 extends vertically upward from the rear end edge of the bottom part 60. The bottom part 60 and the wall part 61 extend in the front-rear direction. The wall part 63 extends in the vertical direction and in the left and right direction.

At the upper part of the wall part 61, an impeller 65A (65) is provided in the vicinity of the end position of the branch extension part 21d of the in-base unit conveyance constituent unit 21. The impeller 65A dispenses the paper sheets S conveyed by the branch extension part 21d and causes the bottom part 60 to stack the paper sheets S. Further, at the upper part of the wall part 61, an impeller 65B (65) is provided in the vicinity of the end position of the branch extension part 21e of the in-base unit conveyance constituent unit 21. Each of the impellers 65A and 65B sandwich each paper sheet S conveyed by the branch extensions 21d and 21e between vanes thereof and rotate. When the paper sheet S abuts the wall part 61 and thereby slips out from between the vanes, the impellers 65A and 65B push the paper sheet S toward the bottom part 60 side with the vanes.

The lower reject accumulating part 12 includes a paper sheet presence/absence detection sensor (not shown) and a presence/absence display illumination (not shown). The paper sheet presence/absence sensor detects the presence or absence of the paper sheet S in the lower reject accumulating part 12. The lighting state of the presence/absence display illumination is switched based on the detection result of the paper sheet presence/absence detection sensor. The presence/absence display illumination is turned on in a state in which the paper sheet S is detected by the paper sheet presence/absence detection sensor as being in the lower reject accumulating part 12. The presence/absence display illumination is extinguished in a state in which the paper sheet S is detected by the paper sheet presence/absence detection sensor as not being in the lower reject accumulating part 12. In addition, the presence/absence display illumination blinks when, for example, the paper sheets S are in a full state in the lower reject accumulating part 12.

The presence/absence display illumination is provided, for example, at the bottom part 60 and emits light outward at the front surface position and the right side surface position of the base unit 2, that is, the paper sheet processing device 1. If there is a cover (not shown) for guiding the paper sheets S dispensed by the impeller 65 and stacking the guided paper sheets S on the bottom part 60, the presence/absence display illumination may be provided on this cover. In that case, the cover may be formed of a transparent material so that the entire cover is illuminated. The upper reject accumulating part 13 also includes the same sheet presence/absence detection sensor and presence/absence display illumination.

The plurality of post-count accumulating parts 14 provided in the sorting-accumulating unit 3 have the same configuration. Each of the plurality of post-count accumulating parts 14 has a bottom part 70, a wall part 72 and a wall part 73. The bottom part 70 is inclined downward to the right with respect to the horizontal. The wall part 72 extends upward from the right end position of the bottom part 70 perpendicularly to the bottom part 70. The wall part 73 extends vertically from the rear end edge of the bottom part 70. The bottom part 70 and the wall part 72 extend in the front-rear direction. The wall part 73 extends in the vertical direction and in the left and right direction. The bottom part 70, the wall part 72 and the wall part 73 are arranged perpendicularly to each other.

At the end of the bottom part 70 opposite to the wall part 72 of each post-count accumulating part 14, an impeller 75 is provided at a position in the vicinity of the post-count accumulating part 14 of the branching conveyance constituent unit 27B. The impeller 75 counts the paper sheets S and dispenses the counted paper sheets S into the post-count accumulating part 14. The impeller 75 sandwiches each paper sheet S conveyed by the branching conveyance constituent unit 27B between vanes thereof and rotates. When the paper sheet S abuts the bottom part 70 and thereby slips out from between the vanes, the impeller 75 pushes the paper sheet S toward the bottom part 72 side with the vanes. As a result, the paper sheets S are stacked in order on the wall part 72 in a state of standing on the bottom part 70 with the short side aligned with the vertical direction. Also in each of the plurality of post-count accumulating parts 14, a paper sheet presence/absence detection sensor and a presence/absence display illumination similar to those provided in the lower reject accumulating part 12 and the upper reject accumulating part 13 are provided. For example, the presence/absence display illumination of the post-count accumulating part 14 is provided at the bottom part 70 and emits light outward at the front surface position of the sorting-accumulating unit 3, that is, the paper sheet processing device 1.

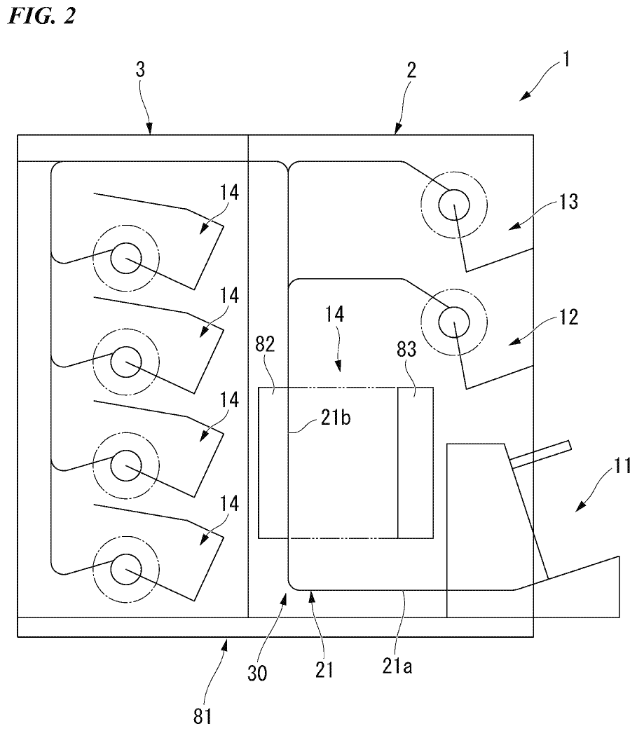

In the paper sheet processing device 1, the receiving part 11 and the identification main body unit 24 are disposed so that the positions thereof overlap in the vertical direction and the front-rear direction. Furthermore, the receiving part 11 and the identification main body unit 24 are provided side by side in the left-right direction of the lateral direction. As shown in FIG. 2, the receiving part 11 is removable to the right side, which is one side in the left-right direction, that is, the opposite side to the identification main body unit 24 (the in-sorting-accumulating unit conveyance constituent unit 27), with respect to a device main body 81 excluding the receiving part 11 of the paper sheet processing device 1. Further, the receiving part 11 can be pushed to the left side, which is the other side in the left-right direction, that is, the identification main body unit 24 side, with respect to the device main body 81 excluding the receiving part 11 of the paper sheet processing device 1. With this configuration, a jammed paper sheet in the leftward extension part 21a can be easily removed by pulling the receiving part 11 to the right to open the leftward extension part 21a.

The identification main body unit 24 is constituted by an identification main body constituent part 82 on the left side, that is, the opposite side to the receiving part 11, and an identification main body constituent part 83 on the right side, that is, the side of the receiving part 11, sandwiching a part of the in-base unit conveyance constituent unit 21 disposed therein. In the state of the receiving part 11 being pulled out from the device main body 81 to the opposite side of the identification main body unit 24 (the in-sorting-accumulating unit conveyance constituent unit 27), the identification main body constituent part 83 of the identification main body unit 24 is slidable to the right, that is, in a direction away from the identification main body constituent part 82. By sliding the identification main body constituent part 83 away from the identification main body constituent part 82 in this way, the identification main body unit 24 is separated in the left-right direction. With this configuration, the identification main body unit 24 can open a portion of the in-base unit conveyance constituent unit 21 disposed inside the identification main body unit 24. In the state of the front door (not shown) of the base unit 2 of the paper sheet processing device 1 being opened, it is possible to easily remove a jammed paper sheet in the identification main body unit 24 by the identification main body unit 24 opening up the in-base unit conveyance constituent unit 21 therein.

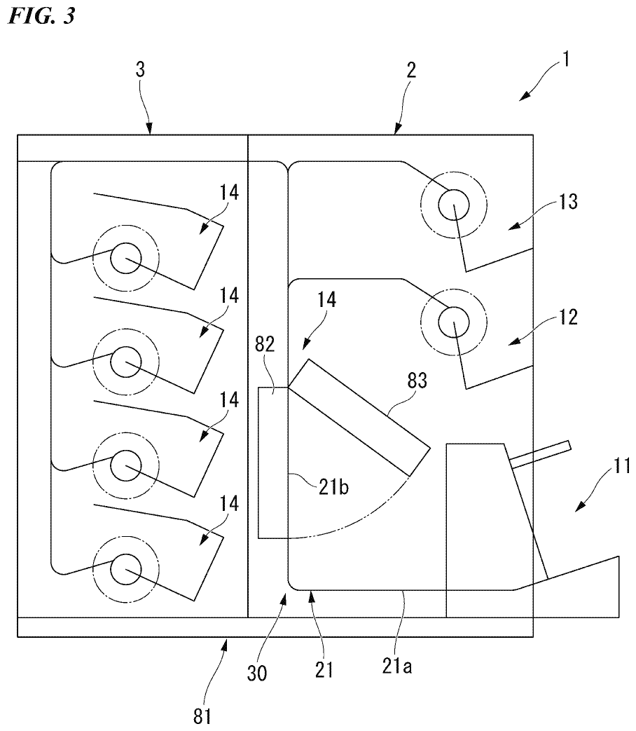

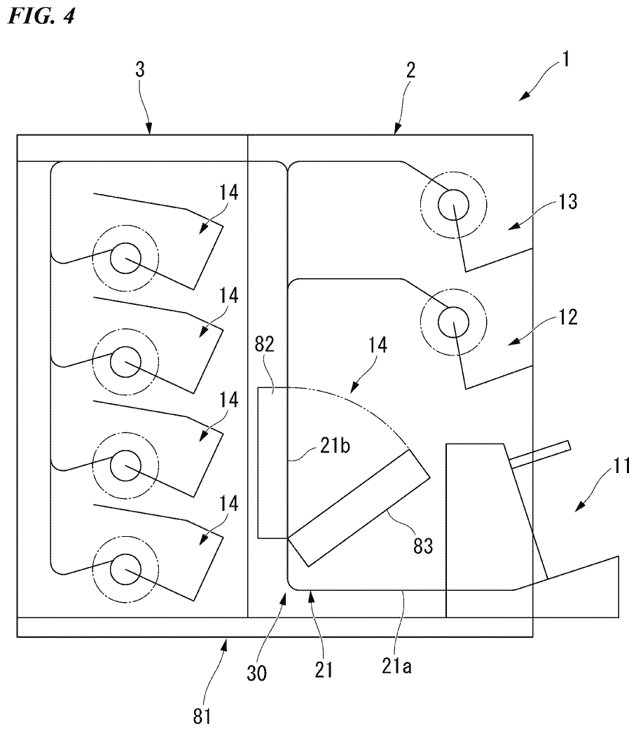

A configuration in which the in-base unit conveyance constituent unit 21 inside the identification main body unit 24 can be opened up is not limited to the configuration in which the identification main constituent part 83 slides in the direction away from the identification main constituent part 82. As shown in FIG. 3, even if the identification main body constituent part 83 is swingable in a direction away from the identification main body constituent part 82 centered on the upper portion thereof, the in-base unit conveyance constituent unit 21 can be opened up. Further, as shown in FIG. 4, even if the identification main body constituent part 83 is swingable in a direction away from the identification main body constituent part 82 centered on the lower portion thereof, the in-base unit conveyance constituent unit 21 can be opened up.

The paper sheet processing device 1 operates in a plurality of operation modes selected by a mode selection operation to the operation display unit 31.

### [First Operation Mode]

In the first operation mode, the lower reject accumulating part 12 is set to a reject provisional accumulating part that accumulates paper sheets S that have a possibility of being accumulated in the post-count accumulating part 14 by being re-identified by the identification unit 22, among the paper sheets S identified as reject paper sheets. Moreover, in the first operation mode, the upper reject accumulating part 13 is set to a reject final accumulating part that accumulates paper sheets S that have no possibility of being accumulated in the post-count accumulating part 14 even if re-identified by the identification unit 22, among the paper sheets S identified as reject paper sheets.

Paper sheets S identified as reject paper sheets that have a possibility of being accumulated in the post-count accumulating part 14 by being re-identified by the identification unit 22 include double-fed paper sheets S, skewed paper sheets S, and near-field paper sheets S in which the interval with a preceding paper sheet S is narrower than a predetermined value, all being detected by the detection unit 23, as well as paper sheets S identified by the identification main body unit 24 and which a accumulating destination, that is, the destination post-count accumulating part 14, cannot completely stack. Paper sheets S identified as reject paper sheets with no possibility of being accumulated in the post-count accumulating part 14 even if re-identified by the identification unit 22 include a counterfeit paper sheet S, a damaged paper sheet S, a paper sheet S on which tape is attached, a paper sheet S with an abnormal ultraviolet inspection, and a paper sheet S which is normal as a paper sheet S but for which there is no post-count accumulating part 14 with the corresponding condition. Old banknotes in the case of new banknote counting modes, and paper sheets with denominations other than 1,000 yen in the case of 1,000 yen note batch counting are examples of a paper sheet S which is normal as a paper sheet S but for which there is no post-count accumulating part 14 with the corresponding condition.

In the first operation mode, the type of paper sheet S as the to-be-counted paper sheet accumulated in each post-count accumulating part 14 is set before the start of the sorting processing. For example, a first post-count accumulating part 14 of the plurality of post-count accumulating parts 14 is set to accumulate 10,000 yen banknotes as the paper sheets S after counting by the identification unit 22. A second post-count accumulating part 14 is set to as to accumulate 5,000 yen banknotes as the paper sheet S after counting by the identification unit 22. A third post-count accumulating part 14 is set to as to accumulate 1,000 yen banknotes as the paper sheet S after counting by the identification unit 22. A fourth post-count accumulating part 14 is set to as to accumulate 2,000 yen banknotes as the paper sheet S after counting by the identification unit 22. In this way, in the case where banknotes are sorted into denominations and accumulated in the post-count accumulating parts 14, the first operation mode is the banknote denomination sorting mode.

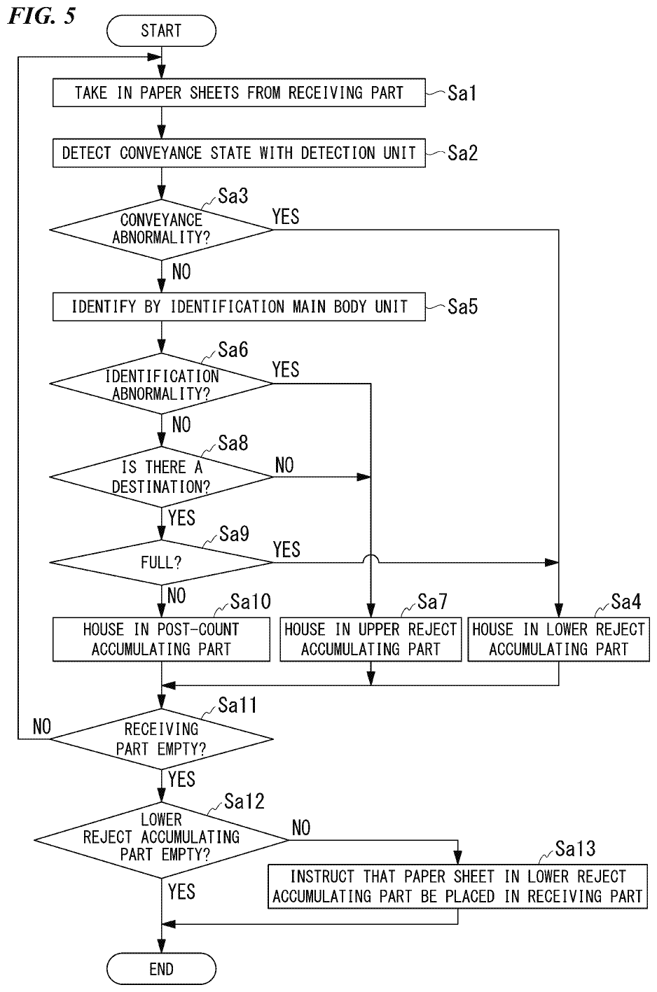

As described above, the first operation mode is executed in a state in which the type of the paper sheet S serving as the to-be-counted paper sheet to be accumulated in each post-count accumulating part 14 has been set. In the first operation mode, in a state in which such a setting has been performed, when the paper sheets S are set in a stacked state in the receiving part 11 and the start operation of one sorting process is input to the operation display unit 31, the control unit 32 performs control following to the flowchart shown in FIG. 5 with regard to the paper sheets S placed in the receiving part 11.

That is, the stacked paper sheets S set in the receiving part 11 are separated and dispensed one by one by the take-in unit 55 and thereby taken into the paper sheet processing device 1 (Step Sa1), with these paper sheets S being conveyed by the conveyance unit 30. Immediately after the start of conveyance by the conveyance unit 30, the detection unit 23 provided in the vicinity of the receiving part 11 detects the conveyance state of each paper sheet S (Step Sa2). When the detection unit 23 detects that the conveyance state of the paper sheet S is an abnormal conveyance state including a double feed, skew feed, and near feed, the control unit 32 determines that this paper sheet S is a reject paper sheet with a conveyance abnormality. In this case, the control unit 32 determines there to be a conveyance abnormality without counting the paper sheet S (Step Sa3: YES) and controls the conveyance unit 30 to convey the paper sheet S to the lower reject accumulating part 12 to be accumulated (Step Sa4).

On the other hand, when the detection unit 23 detects that the conveyance state of the paper sheet S is normal conveyance without any of a double feed, skew feed, and near feed, the control unit 32 determines that there is no conveyance abnormality (Step Sa3: NO). Further, the control unit 32 causes the identification main body unit 24 located downstream of the detection unit 23 of the identification unit 22 to identify the paper sheet S (Step Sa5). If this paper sheet S is identified from the identification result of the identification main body unit 24 as a reject paper sheet with an identification abnormality, such as being counterfeit, damaged, taped, or having an ultraviolet inspection abnormality, the control unit 32 determines there to be an identification abnormality without counting the paper sheet S (Step Sa6: YES). Further, the control unit 32 controls the conveyance unit 30 to convey the paper sheet S to the upper reject accumulating part 13 to be accumulated (Step Sa7).

If the paper sheet S is identified by the identification main body unit 24 as not having an identification abnormality, the control unit 32 determines that there is no identification abnormality (Step Sa6: NO). Next, when the paper sheet S is a reject sheet that does not have the post-count accumulating part 14 serving as a destination, the control unit 32 determines there to be no destination without counting the paper sheet S (Step Sa8: NO). Moreover, the control unit 32 controls the conveyance unit 30 to cause the paper sheet S to be conveyed to the upper reject accumulating part 13 to be accumulated (Step Sa7). If there is a post-count accumulating part 14 serving as the destination of the paper sheet S identified as not having an identification abnormality, the control unit 32 determines that there is a destination (Step Sa8: YES). Next, when the paper sheet S is a reject sheet that cannot be stacked due to the post-count accumulating part 14 being full, the control unit 32 does not count the paper sheet S and determines the post-count accumulating part 14 to be full (Step Sa9: YES). Furthermore, the control unit 32 controls the conveyance unit 30 to convey the paper sheet S to the lower reject accumulating part 12 to be accumulated (Step Sa4).

If the paper sheet S identified as having a post-count accumulating part 14 serving as the destination is identified as a to-be-counted paper sheet that can be accumulated due to the post-count accumulating part 14 serving as the destination not being full, the control unit 32 determines that the post-count accumulating part 14 which is the destination is not full (Step Sa9: NO). Furthermore, the control unit 32 adds one to the type of the paper sheet S, that is, the count value of the denomination. In other words, the control unit 32 increases the count value of the denominations of this paper sheet S. Furthermore, the control unit 32 controls the conveyance unit 30 to convey the paper sheet S to the corresponding the post-count accumulating part 14 to be accumulated (Step Sa10).

As described above, the post-count accumulating part 14 accommodates the paper sheets S that have been identified by the identification unit 22 as to-be-counted paper sheets and counted. The lower reject accumulating part 12 and the upper reject accumulating part 13 accumulate, in a sorted state, the paper sheets S identified as the reject paper sheets by the identification unit 22 and sorted by reason for rejection. At that time, the lower reject accumulating part 12 accumulates double-fed paper sheets S, skewed paper sheets S, near-field paper sheets S and paper sheets S that are rejected for being unstackable as a result of the post-count accumulating part 14 serving as the destination being full, all of which have a possibility of being accumulated in the post-count accumulating part 14 by being re-identified by the identification unit 22. In addition, the upper reject accumulating part 13 accumulates counterfeit paper sheets S, damaged paper sheets S, paper sheets S on which tape is attached, paper sheets S with an abnormal ultraviolet inspection, and paper sheets S which are normal as paper sheets S but for which there is no post-count accumulating part 14 with the corresponding condition, all of which have no possibility of being accumulated in the post-count accumulating part 14 even if re-identified by the identification unit 22.

After Steps Sa4, Sa7 and Sa10, if there is a paper sheet S in the receiving part 11, the control unit 32 determines that the receiving part 11 is not empty (Step Sa11: NO) and returns to Step Sa1. Further, the control unit 32 causes the next paper sheet S to be taken into the paper sheet processing device 1 from the receiving part 11. If there is no paper sheet S in the receiving part 11, the control unit 32 determines that the receiving part 11 is empty (Step Sa11: YES). In the state where the receiving part 11 is empty, all the paper sheets S that were set in the receiving part 11 have been accumulated in any one of the lower reject accumulating part 12, the upper reject accumulating part 13 and the post-count accumulating parts 14.

Next, when there is a paper sheet S accumulated in the lower reject accumulating part 12, the control unit 32 determines that the lower reject accumulating part 12 is not empty (Step Sa12: NO). Moreover, the control unit 32 gives notice, by the lighted state of the presence/absence display illumination provided in the lower reject accumulating part 12 and a display on the operation display unit 31, of a display instructing that the paper sheet S accumulated in the lower reject accumulating part 12 be placed in the receiving part 11 (Step Sa13). In other words, when a paper sheet S that has a possibility of being accumulated in the post-count accumulating part 14 by re-identification by the identification unit 22 is in the lower reject accumulating part 12, the control unit 32 informs the operator to place the paper sheet S in the receiving part 11. Specifically, the control unit 32 switches the presence/absence display illumination of the lower reject accumulating part 12 that turned on by the paper sheet S being accumulated in the lower reject accumulating part 12 to the blinking state. At the same time, the control unit 32 causes the operation display unit 31 to perform a display prompting the return of the paper sheet S from the lower reject accumulating part 12 to the receiving part 11.

By such notification, the operator sets the paper sheet S accumulated in the lower reject accumulating part 12 in the receiving part 11, and inputs the restart operation for one sorting process to the operation display unit 31. Then, the control unit 32 again performs control according to the flowchart shown in FIG. 5 with regard to paper sheets S placed again in the receiving part 11. As a result, the paper sheet S accumulated in the lower reject accumulating part 12 is again identified by the identification unit 22. For the paper sheet S that has been identified as having no conveyance abnormality (Step Sa3: NO), no identification abnormality (Step Sa6: NO), a destination (Step Sa8: YES), and a destination that is not full (Step Sa9: NO), the control unit 32 adds one to the count value of that type, that is, that denomination. Further, the control unit 32 controls the conveyance unit 30 to convey the paper sheet S to the corresponding post-count accumulating part 14 to be accumulated.

If there is no paper sheet S accumulated in the lower reject accumulating part 12, the control unit 32 determines that the lower reject accumulating part 12 is empty (Step Sa12: YES), and ends this one sorting process. Note that there is a possibility that the paper sheet S will again be accumulated in the lower reject accumulating part 12 after being identified again by the identification unit 22. For this reason, one sorting process can be forcefully terminated by an operation input to the operation display unit 31 displaying the notification screen in Step Sa13.

Here, the case of one sorting process in the first operation mode will be described in which, in the state of all the paper sheets S set in the receiving part 11 having been accumulated in any of the lower reject accumulating part 12, the upper reject accumulating part 13 and the post-count accumulating parts 14, the paper sheet S accumulated in the lower reject accumulating part 12 is only one paper sheet S with the reason for rejection thereof being skewed banknote or the like. In this case, the identification of this one paper sheet S by the identification main body unit 24 is completed. For this reason, when this one paper sheet S is subsequently dispersed from the receiving part 11 in the same sorting process, and the conveyance state of the paper sheet S is detected as normal conveyance by the detection unit 23, the paper sheet S may be accumulated in the post-count accumulating part 14 of the denomination corresponding to this one paper sheet S without being re-identified by the identification main body unit 24.

In the first operation mode, the sorting of the paper sheets S accumulated in the lower reject accumulating part 12 and the upper reject accumulating part 13 may be reversed. That is, the upper reject accumulating part 13 may be set to the reject provisional accumulating part that accumulates paper sheets S identified as reject paper sheets that have a possibility of being accumulated in the post-count accumulating part 14 by re-identification by the identification unit 22, and the lower reject accumulating part 12 may be set to the reject final accumulating part that accumulates the paper sheets S identified as paper sheets having no possibility of being accumulated in the post-count accumulating part 14 even if re-identified by the identification unit 22.

### [Second Operation Mode]

In the second operation mode, the upper reject accumulating part 13 accumulates the paper sheet S identified as a reject paper sheet that is a casino ticket (voucher), and the lower reject accumulating part 12 accumulates the paper sheet S identified as a reject paper sheet other than a casino ticket.

In the second operation mode, as in the first operation mode, the type of the paper sheet S as the to-be-counted paper sheet S to be accumulated in each post-count accumulating part 14 is set before the start of the sorting process.

In the second operation mode, among the paper sheets S in which banknotes and casino tickets are mixed, the banknotes are sorted into denominations while being counted, and the casino tickets are gathered together and accumulated while being counted according to type. That is, the second operation mode is a mode in which banknotes and casino tickets are separated while sorting the banknotes. The casino tickets are paper sheets of a different type than banknotes.

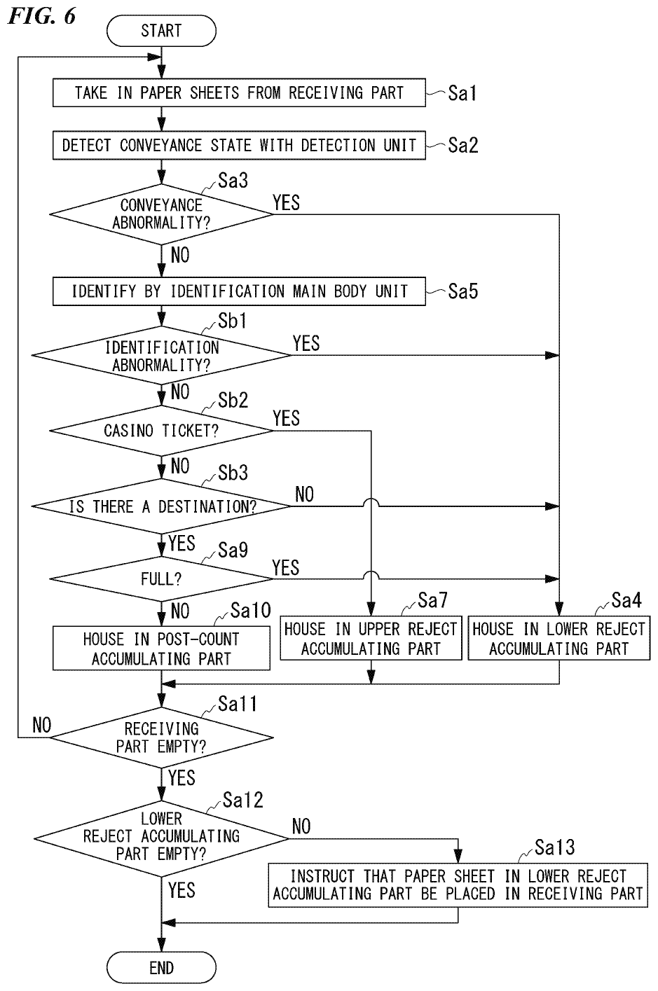

In the second operation mode, when paper sheets S are set in a stacked state in the receiving part 11 and the start operation of one sorting process is input to the operation display unit 31, the control unit 32 performs control following to the flowchart shown in FIG. 6 with regard to the paper sheets S set into the receiving part 11.

That is, the stacked paper sheets S set in the receiving part 11 are separated and dispensed one by one by the take-in unit 55 (Step Sa1), and the paper sheets S are conveyed by the conveyance unit 30. Immediately after the start of conveyance by the conveyance unit 30, the detection unit 23 provided in the vicinity of the receiving part 11 detects the conveyance state of the paper sheet S (Step Sa2). When the detection unit 23 detects that the conveyance state of the paper sheet S is an abnormal conveyance state including a double feed, skew feed, and near feed, the control unit 32 determines that this paper sheet S is a reject paper sheet with a conveyance abnormality. In this case, the control unit 32 determines there to be a conveyance abnormality without counting the paper sheet S (Step Sa3: YES) and controls the conveyance unit 30 to convey the paper sheet S to the lower reject accumulating part 12 to be accumulated (Step Sa4).

If the paper sheet S is determined by the detection unit 23 to have normal conveyance without any of double feeding, skew feeding, and near feeding, the control unit 32 determines there to be no conveyance abnormality (Step Sa3: NO). Moreover, the control unit 32 causes the identification main body unit 24 of the identification unit 22 to identify the paper sheet S (Step Sa5). If this sheet S is identified from the identification result of the identification main body unit 24 as a reject paper sheet with an identification abnormality including being counterfeit, damaged, taped, or having an ultraviolet inspection abnormality, the control unit 32 determines there to be an identification abnormality without counting the paper sheet S (Step Sb1: YES). Further, the control unit 32 controls the conveyance unit 30 to convey the paper sheet S to the lower reject accumulating part 12 to be accumulated (Step Sa4). Here, in the second operation mode, when the identified paper sheet S is identified as a casino ticket registered in advance in Step Say, the control unit 32 determines that there is no identification abnormality regarding the paper sheet S.

If the paper sheet S is identified by the identification main body unit 24 as not having an identification abnormality, the control unit 32 determines that there is no identification abnormality (Step Sb1: NO). Next, when the paper sheet S is identified by the identification main body unit 24 as being a casino ticket registered in advance (Step Sb2: YES), the control unit 32 adds one to the count value of this type of paper sheet S. Moreover, the control unit 32 controls the conveyance unit 30 to convey this paper sheet S to the upper reject accumulating part 13 to be accumulated (Step Sa7). When the paper sheet S is identified by the identification main body unit 24 as not being a casino ticket registered in advance (Step Sb2: NO), the process proceeds to Step Sb3. The control unit 32 determines whether there is a post-count accumulating part 14 which is the destination of the paper sheet S. If the paper sheet S is a reject paper sheet having no post-count accumulating part 14 serving as the destination, the control unit 32 determines that there is no destination without counting the paper sheet S (Step Sb3: NO). Further, the control unit 32 controls the conveyance unit 30 to convey the paper sheet S to the lower reject accumulating part 12 to be accumulated (Step Sa4). If there is a post-count accumulating part 14 serving as the destination of the paper sheet S identified as not having an identification abnormality and as not being a casino ticket registered in advance, the control unit 32 determines that there is a destination (Step Sb3: YES). Next, when the paper sheet S is a reject paper sheet that cannot be stacked because the post-count accumulating part 14 serving as the destination is full, the control unit 32 determines that the post-count accumulating part 14 serving as the destination is full without counting the paper sheet S (Step Sa9: YES). Further, the control unit 32 controls the conveyance unit 30 to convey the paper sheet S to the lower reject accumulating part 12 to be accumulated (Step Sa4).

When the paper sheet S identified as having the post-count accumulating part 14 serving as the destination is a to-be-counted paper sheet that can be accumulated due to the post-count accumulating part 14 serving as the destination not being full, the control unit 32 determines that the post-count accumulating part 14 serving as the destination is not full (Step Sa9: NO). Furthermore, the control unit 32 adds one to the count value of that type of the paper sheet S, that is, the denomination. Furthermore, the control unit 32 controls the conveyance unit 30 to convey the paper sheet S to the corresponding post-count accumulating part 14 to be accumulated (Step Sa10).

As described above, the post-count accumulating part 14 accumulates the paper sheets S that have been identified as a to-be-counted paper sheet by the identification unit 22 and counted. The lower reject accumulating part 12 and the upper reject accumulating part 13 accumulate the paper sheets S that have been identified as reject sheets by the identification unit 22 in a state sorted by reason for rejection. At that time, the upper reject accumulating part 13 accumulates the paper sheets S identified as casino tickets, and the lower reject accumulating part 12 accumulates the paper sheets S identified as reject paper sheets other than casino tickets.

Next, if there is a paper sheet S in the receiving part 11, the control unit 32 determines that the receiving part 11 is not empty (Step Sa11: NO) and returns to Step Sa1. Next, the control unit 32 causes the next paper sheet S to be taken in from the receiving part 11. If there is no paper sheet S in the receiving part 11, the control unit 32 determines that the receiving part 11 is empty (Step Sa11: YES). If there is a paper sheet S accumulated in the lower reject accumulating part 12, the control unit 32 determines that the lower reject accumulating part 12 is not empty (Step Sa12: NO). Furthermore, the control unit 32 performs notification, by the lighted state of the presence/absence display illumination provided in the lower reject accumulating part 12 and a display on the operation display unit 31, of a display prompting the setting of the paper sheet S accumulated in the lower reject accumulating part 12 in the receiving part 11 (Step Sa13).

By such notification, the operator sets the paper sheet S accumulated in the lower reject accumulating part 12 in the receiving part 11, and inputs the restart operation for one sorting process to the operation display unit 31. Then, the control unit 32 again performs control according to the flowchart shown in FIG. 6 with regard to paper sheets S placed again in the receiving part 11. As a result, the paper sheet S accumulated in the lower reject accumulating part 12 is again identified by the identification unit 22. For the paper sheet S that has been identified as having no conveyance abnormality (Step Sa3: NO), no identification abnormality (Step Sb1: NO), as not being a casino ticket (Step Sb2: NO), as having a destination (Step Sb3: YES), and a destination that is not full (Step Sa9: NO), the control unit 32 adds one to the count value of that type, that is, that denomination. Further, the control unit 32 controls the conveyance unit 30 to convey the paper sheet S to the corresponding post-count accumulating part 14 to be accumulated.

If there is no paper sheet S accumulated in the lower reject accumulating part 12, the control unit 32 determines that the lower reject accumulating part 12 is empty (Step Sa12: YES), and ends this one sorting process.

Here, in the second operation mode, the sorting of the paper sheets S accumulated in the lower reject accumulating part 12 and the upper reject accumulating part 13 may be reversed. That is, the lower reject accumulating part 12 may be made to accumulate paper sheets S identified as casino tickets, and the upper reject accumulating part 13 may be made to accumulate paper sheets identified as reject paper sheets other than casino tickets.

In the second operation mode, when it is determined that the receiving part 11 is empty (Step Sa11: YES), the following processing may be performed. That is, if there is a paper sheet S stored in the upper reject accumulating part 13, the control unit 32, without performing Steps Sa12 and Sa13, prompts an input to be made to the operation display unit 31 whether or not classification of the amount or type of a casino ticket is necessary. If classification the amount or type of the casino ticket is necessary, the control unit 32 empties the upper reject accumulating part 13 and the lower reject accumulating part 12 and instructs that the casino ticket accumulated in the upper reject accumulating part 13 be placed again in the receiving part 11. Thereafter, when a restart operation is input to the operation display unit 31, the control unit 32 may identify with the identification unit 22 the casino ticket that has been placed again to the receiving part 11, and depending on the amount or type thereof, classify the casino ticket to the upper reject accumulating part 13 or the lower reject accumulating part 12 to be accumulated.

### [Third Operation Mode]

In the third operation mode (serial number identification mode), the upper reject accumulating part 13 accumulates a paper sheet S which has been identified as a reject paper sheet due to the serial number of the banknote. The lower reject accumulating part 12 accumulates a paper sheet S identified as a reject paper sheet other than the paper sheet S identified as a reject sheet due to the serial number thereof. Also in the third operation mode, it is possible to separate the paper sheet S identified as a reject paper sheet due to the serial number thereof while sorting banknotes and accumulating the banknotes in the post-count accumulating part 14. Here, a paper sheet identified as a reject paper sheet due to the serial number includes a paper sheet in which the serial number cannot be read by the identification main body unit 24, a paper sheet in which, when two serial numbers are printed thereon, the numbers at the two locations differ, and a paper sheet that is identified as having a serial number registered as a counterfeit banknote.

In the third operation mode, the classification of the paper sheets S accumulated in the lower reject accumulating part 12 and the upper reject accumulating part 13 may be reversed. That is, the lower reject accumulating part 12 may be set to accumulate a paper sheet S identified as a reject paper sheet due to the serial number of the banknote, and the upper reject accumulating part 13 may be set to accumulate a paper sheet S identified as a reject paper sheet other than the paper sheet S identified as a reject paper sheet due to the serial number thereof.

In the third operation mode, the following processing may be performed. That is, the control unit 32 gives notice prompting the re-input into the receiving part 11 of paper sheets S accumulated in the upper reject accumulating part 13 and identified as reject paper sheets due to the serial numbers. When the paper sheets S are re-input to the receiving part 11 and a restart operation is input to the operation display unit 31, the control unit 32 accumulates a paper sheet S identified as a banknote in which the serial number cannot be read and a paper sheet S identified as a banknote in which the numbers at two locations are different (which may include a paper sheet S having a problem being read due to grime or the like) in one of the upper reject accumulating part 13 and the lower reject accumulating part 12. Both the paper sheet S identified as a banknote in which the serial number cannot be read and the paper sheet S identified as a banknote in which the numbers at two locations are different have the possibility of being accumulated in the post-count accumulating part 14 by being re-identified by the identification unit 22. On the other hand, the control unit 32 accumulates a paper sheet S detected as a counterfeit note having no possibility of being accumulated in the post-count accumulating part 14 even if re-identified by the identification unit 22 in the other of the upper reject accumulating part 13 and the lower reject accumulating part 12.

In any of the first to third operation modes, when any one of the lower reject accumulating part 12, the upper reject accumulating part 13, and the plurality of post-count accumulating parts 14 becomes full, the control unit 32 switches the presence/absence display illumination (not shown) to a blinking state and causes the operation display unit 31 to perform a display instructing the extraction of the paper sheets S in the full-state accumulating part.

The selection of the first to third operation modes may be performed by, for example, an operation input to the operation display unit 31, but is not limited to such a configuration. For example, in the case of a paper sheet S initially dispensed from the receiving part 11 and identified by the identification unit 22 as being a banknote, the first operation mode may be automatically set. In the case of a paper sheet S initially dispensed from the receiving part 11 and identified by the identification unit 22 as being a casino ticket, the second operation mode may be automatically set. Only the third operation mode may be selected by an operation input to the operation display unit 31.

The paper sheet processing device 1 of the first embodiment described above has the lower reject accumulating part 12 and the upper reject accumulating part 13 that accumulate, in a state sorted by reason for rejection, the paper sheets S identified as reject paper sheets by the identification unit 22. For this reason, it is possible to classify by reason for rejection the paper sheets S identified as reject paper sheets and classify the paper sheets S into banknotes with a specific reason for rejection and banknotes with other reasons for rejection. Therefore, it is possible to improve the efficiency of the subsequent processing performed on the paper sheets S identified as a reject paper sheets.

For example, a banknote processing device of the related art has one reject accumulating part for accumulating unrecognizable banknotes that cannot be identified and banknotes that cannot be accepted due to double feeding and the like, among paper sheets placed in the receiving part. Among the banknotes accumulated in this reject accumulating part, depending on the reason for rejection (for example, double feeding, skew, near feed, etc.), the paper sheet may be accepted by being re-inserted into the receiving part and re-identified. On the other hand, depending on the reason for rejection (for example, counterfeit, damaged, taped, or having an ultraviolet inspection abnormality), there are also paper sheets for which, during the initial identification, a determination is made that even if re-identified would not be identified as reject paper sheets.

According to the paper sheet processing device 1 of the first embodiment, in the first operation mode, the lower reject accumulating part 12 that is set as a reject provisional accumulating part accumulates paper sheets S with a reason for rejection (for example double feed, skew, near feed and the like) in which there is a possibility of being accumulated in the post-count accumulating part 14 by re-identification by the identification unit 22, among the paper sheets S identified as reject paper sheets. On the other hand, the upper reject accumulating part 13 accumulates paper sheets S with a reason for rejection (for example, counterfeit, damaged, taped, or having an ultraviolet inspection abnormality) in which there is no possibility of being accumulated in the post-count accumulating part 14 even if re-identified by the identification unit 22, among the paper sheets S identified as reject paper sheets. As a result, if only the paper sheets S accumulated in the lower reject accumulating part 12 are re-identified by the identification unit 22, the paper sheets S identified as to-be-counted paper sheets by this re-identification can be accumulated in the post-count accumulating part 14. Therefore, the time required for the re-identification process can be shortened as compared to the case where all the paper sheets S identified as reject sheets are re-identified.

Among the lower reject accumulating part 12 and the upper reject accumulating part 13, the paper sheets S with a reason for rejection in which there is a possibility of being accumulated in the post-count accumulating part 14 by re-identification by the identification unit 22 are accumulated in the lower reject accumulating part 12 that is close to the receiving part 11. Therefore, the moving distance of the paper sheets S to the receiving part 11 when being re-set can be shortened, and the workability of the re-set is good. Among the lower reject accumulating part 12 and the upper reject accumulating part 13, the paper sheets S with a reason for rejection in which there is a possibility of being accumulated in the post-count accumulating part 14 by re-identification by the identification unit 22 can also be accumulated in the upper reject accumulating part 13 on the upper side. In this case, it is possible to easily visually recognize the presence or absence of a paper sheet S with a reason for rejection in which there is a possibility of being accumulated in the post-count accumulating part 14 by re-identification by the identification unit 22.

In the second operation mode, the upper reject accumulating part 13 set as a casino ticket accumulating part accumulates paper sheets S that have been identified as casino tickets registered in advance among the paper sheets S identified as reject paper sheets. Also, the lower reject accumulating part 12 accumulates paper sheets S other than the paper sheets S identified as casino tickets registered in advance among the paper sheets S identified as reject paper sheets. Accordingly, the time required for the process of separating casino tickets registered in advance from other reject paper sheets can be shortened.

Further, in the first operation mode, when a paper sheet S identified as a reject paper sheet and accumulated in the lower reject accumulating part 12 set as a reject provisional accumulating part is a single paper sheet S whose reason for rejection is being skewed or the like, thereafter, when this one paper sheet S is dispensed from the receiving part 11 and the conveyance state thereof is detected by the detection unit 23 as normal conveyance, the paper sheet S is accumulated in the corresponding post-count accumulating part 14 without being re-identified by the identification main body unit 24. For this reason, power consumption can be reduced, and processing can be speeded up. Of course, the paper sheet S may be re-identified by the identification main body unit 24 and the result ignored. Alternatively, a separate conveyance path that does not pass through the identification main body unit 24 may be provided, and the paper sheet S may be conveyed through this separate conveyance path and accumulated in the corresponding post-count accumulating part 14.

Further, by pulling out the receiving part 11 from the device main body 81 in the lateral direction to the opposite side of the identification unit 22, the identification unit 22 and the conveyance unit 30 (the leftward extension part 21a) can be opened. Therefore, it becomes easy to take out jammed paper sheets. In addition, since it is not necessary to operate the conveyance unit 30 for taking out jammed paper sheets, the degree of freedom of the conveyance route can be enhanced, and downsizing of the paper sheet processing device 1 can be realized.

### Second Embodiment

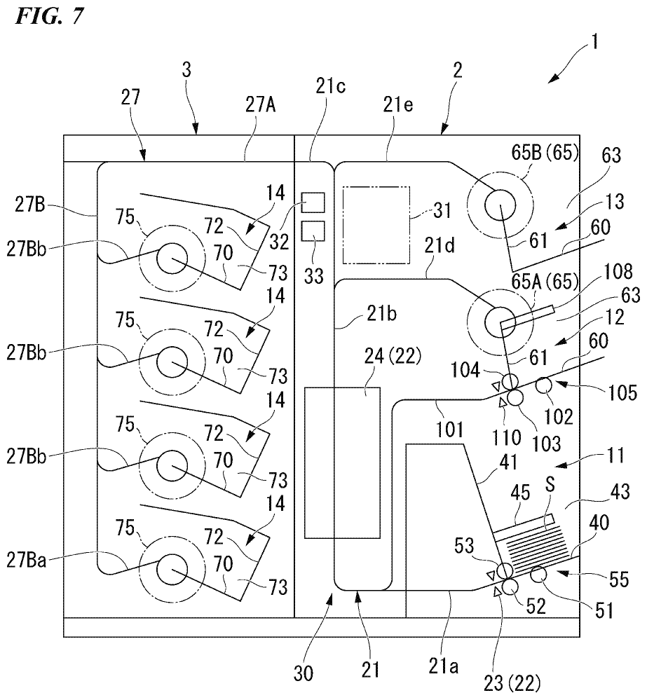

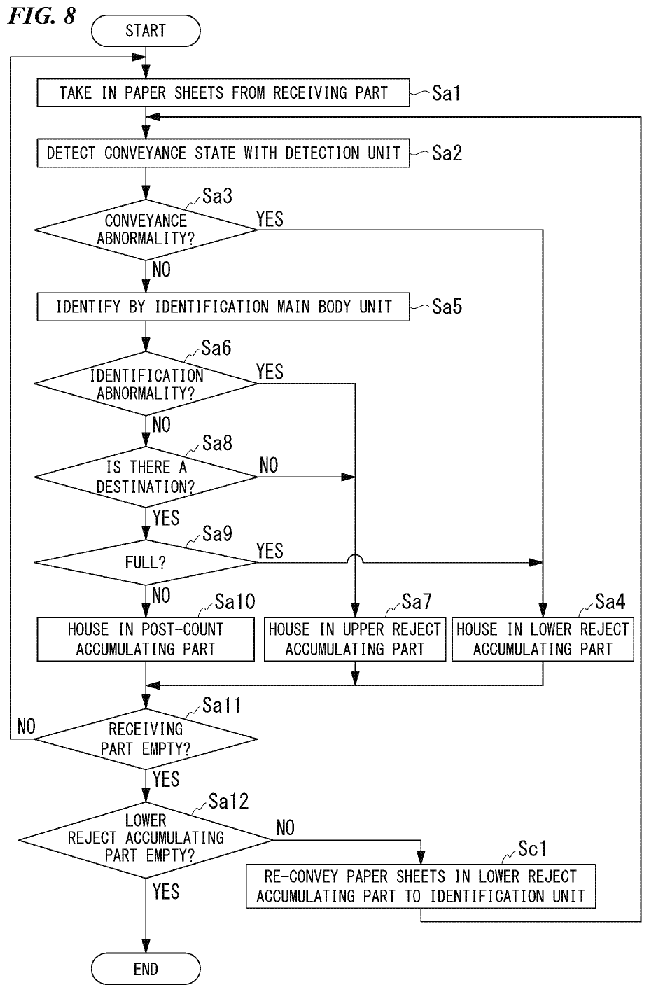

A sheet processing device according to a second embodiment of the present invention will be described below with reference to FIGS. 7 and 8, focusing on differences with the first embodiment.

In the second embodiment, the lower reject accumulating part 12, which is closer to the receiving part 11 among the lower reject accumulating part 12 and the upper reject accumulating part 13, is capable of dispensing paper sheets S accumulated therein one by one from the lowermost one. In addition, a return conveyance unit 101 is provided that conveys the paper sheet S dispensed from the lower reject accumulating part 12 to the identification unit 22 together with the conveyance unit 30. The return conveyance unit 101 extends from the bottom part 60 of the lower reject accumulating part 12 and meets between the detection unit 23 of the in-base unit conveyance constituent unit 21 and the identification main body unit 24. The return conveyance unit 101 may constitute a part of the conveyance unit 30.

The lower reject accumulating part 12 of the second embodiment has a kick-out roller 102, a delivery roller 103 and a separation roller 104. The kick-out roller 102 is provided at the bottom part 60, and by abutting against the lowermost paper sheet S among the paper sheets S stacked on the bottom part 60, kicks out the lowermost paper sheet S to the return conveyance unit 101 side. The delivery roller 103 returns and dispenses to the return conveyance unit 101 the paper sheet S kicked out by the kick-out roller 102. The separation roller 104 separates the paper sheets S dispensed by the delivery roller 103 one by one. The kick-out roller 102, the delivery roller 103, and the separation roller 104 constitute a delivery unit 105 that separates and dispenses the paper sheets S of the lower reject accumulating part 12 one by one. A bill press 108 is provided above the bottom part 60 of the lower reject accumulating part 12 of the second embodiment. The bill press 108 moves up and down according to control of the control unit 32. The bill press 108 presses the paper sheets S placed on the bottom part 60 toward the bottom part 60.

In the second embodiment, the identification unit 22 includes a detection unit 110 in addition to the detection unit 23 and the identification main body unit 24 of the first embodiment. The detection unit 110 is provided at an end position on the lower reject accumulating part 12 side of the return conveyance unit 101, and detects the conveyance state of the paper sheet S dispensed by the lower reject accumulating part 12. The detection unit 110 detects the conveyance state of the paper sheet S in the same manner as the detection unit 23.

Also in the second embodiment, as in the first operation mode of the first embodiment, the lower reject accumulating part 12 is set to a reject provisional accumulating part that accumulates paper sheets S that have a possibility of being accumulated in the post-count accumulating part 14 by being re-identified by the identification unit 22, among the paper sheets S identified as reject paper sheets. Moreover, the upper reject accumulating part 13 is set to a reject final accumulating part that accumulates paper sheets S that have no possibility of being accumulated in the post-count accumulating part 14 even if re-identified by the identification unit 22, among the paper sheets S identified as reject paper sheets.

In the second embodiment, when the paper sheets S are set in a stacked state in the receiving part 11 and the start operation of one sorting process is input to the operation display unit 31, the control unit 32 performs control following the flowchart shown in FIG. 8 for the paper sheets S set in the receiving part 11.

That is, the control unit 32 performs steps Sa1 to Sa11 similarly to the first operation mode of the first embodiment. If the control unit 32 determines in Step Sa11 that there are no paper sheets S in the receiving part 11 and therefore that the receiving part 11 is empty (Step Sa11: YES), the process proceeds to Step Sa12. If there is a paper sheet S accumulated in the lower reject accumulating part 12, the control unit 32 determines that the lower reject accumulating part 12 is not empty (Step Sa 12: NO), and the delivery unit 105 automatically dispenses the paper sheets S accumulated in the lower reject accumulating part 12 one-by-one to the return conveyance unit 101 to be re-conveyed to the identification unit 22 (Step Sc1). Thereby, after the conveyance state of the paper sheets S dispensed from the lower reject accumulating part 12 is detected by the detection unit 110 (Step Sa2), the paper sheets S are identified again by the identification main body unit 24. At that time, the detection unit 110 identifies that there is no conveyance abnormality (Step Sa3: NO), the identification main body unit 24 identifies that there is no identification abnormality (Step Sa6: NO), and identifies that there is a destination (Step Sa8: YES). If it is determined that the destination is not full (Step Sa9: NO), the control unit 32 adds one to the type of the paper sheet S, that is, the count value of the denomination. Further, the control unit 32 controls the conveyance unit 30 to convey the paper sheet S to the corresponding post-count accumulating part 14 to be accumulated (Step Sa10). If there is no paper sheet S accumulated in the lower reject accumulating part 12, it is determined that the lower reject accumulating part 12 is empty (Step Sa12: YES), and the one sorting process is completed. Note that there is a possibility that the paper sheet S that has been identified again by the identification main body unit 24 being accumulated once again in the lower reject accumulating part 12. For this reason, in one sorting process, when Step Sc1 is performed a predetermined number of times or a predetermined time has elapsed, the one sorting process is forcibly terminated.

The case will be described in the second embodiment in which, in the state of all the paper sheets S set in the receiving part 11 having been accumulated in any of the lower reject accumulating part 12, the upper reject accumulating part 13 and the post-count accumulating parts 14, the paper sheet S accumulated in the lower reject accumulating part 12 is only one paper sheet S whose reason for rejection is being skewed or the like. In this case, the identification of this one paper sheet S by the identification main body unit 24 is completed. For this reason, the control unit 32 subsequently dispenses this single paper sheet S from the lower reject accumulating part 12 automatically. If it is determined by the detection unit 110 that the conveyance state of the paper sheet S is normal conveyance, the control unit 32 accumulates the paper sheet S in the post-count accumulating part 14 of the denomination corresponding to this one paper sheet S, without identifying the paper sheet S by the identification main body unit 24 again.

That is, in the second embodiment there is provided the return conveyance path 101 for guiding the paper sheet S stored in the lower reject accumulating unit 12, which is close to the receiving part 11, to the identification main body unit 24 again. The lower reject accumulating unit 12 accumulates paper sheets S with a possibility of being acceptable by re-identification. The paper sheets S in the lower reject accumulating unit 12 are automatically re-identified.

According to the paper sheet processing device 1 of the second embodiment described above, the lower reject accumulating part 12, which accumulates paper sheets S that have a possibility of being accumulated in the post-count accumulating part 14 by being re-identified by the identification unit 22, among the paper sheets S identified as reject paper sheets, dispenses the paper sheets S one by one, and the return conveyance unit 101 conveys the paper sheets S to the identification unit 22 that includes the detection unit 110 and the identification main body unit 24. For this reason, it is possible to automatically re-identify the paper sheets S in the lower reject accumulating part 12. Therefore, since a return operation of the paper sheets S by a manual operation of the operator becomes unnecessary, it becomes possible to perform banknote processing more efficiently.

In addition, in the case of the paper sheet S that is identified as a reject paper sheet and accumulated in the lower reject accumulating part 12 being a single paper sheet S whose reason for rejection is being skewed or the like, when this one paper sheet S is subsequently dispensed from the lower reject accumulating part 12 and the conveyance state thereof is determined to be normal conveyance by the detection unit 110, the paper sheet S is accumulated in the corresponding post-count accumulating part 14 without being re-identified by the identification main body unit 24. For this reason, power consumption can be reduced, and processing can be speeded up. Of course, the paper sheet S may be re-identified by the identification main body unit 24 and the result ignored. Alternatively, a separate conveyance path that does not pass through the identification main body unit 24 may be provided, and the paper sheet S may be conveyed through this separate conveyance path and accumulated in the corresponding post-count accumulating part 14.

The second embodiment is not limited to a configuration provided with the return conveyance unit 101 and the delivery unit 105. A lift may be provided to move the paper sheets S accumulated in the lower reject accumulating part 12 to the receiving part 11 in the stacked state. The control unit 32 may move the paper sheets S stored in the lower reject accumulating part 12 to the receiving part 11 with this lift, and continuously dispense the paper sheets S one by one from the receiving part 11.

### Third Embodiment

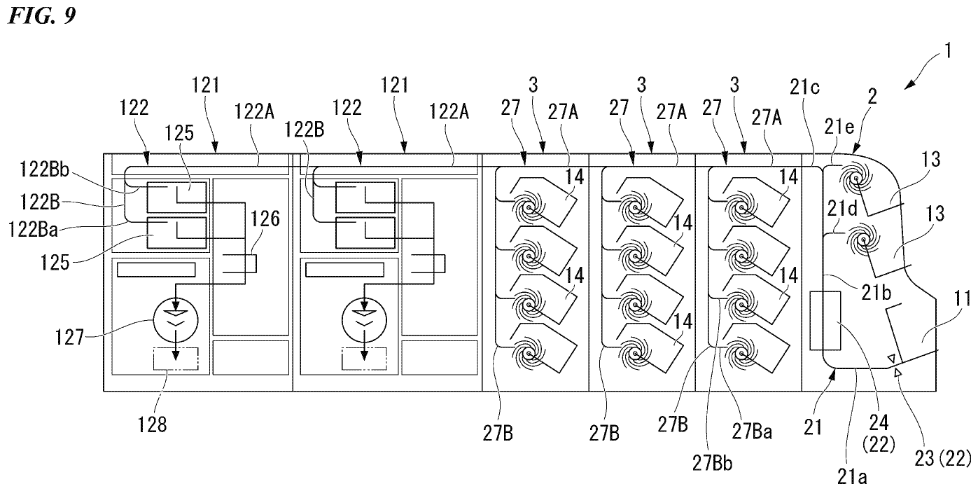

A paper sheet processing device according to a third embodiment of the present invention will be described below with reference to FIG. 9, focusing on differences with the first embodiment.

A plurality of sorting-accumulating units 3 can be connected consecutively to the base unit 2 as processing units. Further, a plurality of bundling units 121 can be connected consecutively to the base unit 2. In the paper sheet processing device 1 of the third embodiment, a plurality of the sorting-accumulating units 3 similar to those of the first embodiment, specifically, three units, are connected consecutively to the base unit 2. Further, on the side opposite to that of the base unit 2, a plurality of bundling units 121, specifically two, are consecutively connected as processing units. As in the first embodiment, in each of the three sorting-accumulating units 3, the coupling conveyance constituent unit 27A and the branching conveyance constituent unit 27B can be driven independently.

The bundling unit 121 includes an in-bundling unit conveyance constituent unit 122 (in-processing unit conveyance constituent unit). The in-bundling unit conveyance constituent unit 122 is provided with a coupling conveyance constituent unit 122A and a branching conveyance constituent unit 122B. The coupling conveyance constituent unit 122A opens to the upper part of the right side surface of the bundling unit 121, extends horizontally and linearly toward the left side surface of the bundling unit 121, and opens at the left side surface. The branching conveyance constituent unit 122B branches downward from the left portion of the coupling conveyance constituent unit 122A. The coupling conveyance constituent unit 122A and the branching conveyance constituent unit 122B each have separate drive motors, and can be driven independently.

The branching conveyance constituent unit 122B has a downward extension part 122Ba and a branch extension part 122Bb. The downward extension part 122Ba is branched from the coupling conveyance constituent unit 122A, and after extending vertically downward, extends in the direction of the right side surface of the bundling unit 121. The branch extension part 122Bb branches from the downward extension part 122Ba and extends in the direction of the right side surface of the bundling unit 121.

The bundling unit 121 includes an aligning-stacking unit 125 connected to the end position of the downward extension part 122Ba and the end position of the branch extension part 122Bb. The aligning-stacking unit 125 aligns and stacks the paper sheets S in a predetermined number (for example, 100). The bundling unit 121 has a downward conveying unit 126 on the right side of the aligning-stacking unit 125. The downward conveying unit 126 loads stacked banknotes sent out to the right from the aligning-stacking unit 125 and conveys the stacked banknotes vertically downward. In addition, the bundling unit 121 has a bundling unit 127 below the aligning-stacking unit 125. The bundling unit 127 produces a small banknote bundle by bundling with bundling tape the stacked banknotes conveyed downward by the downward conveying unit 126 and sent out to the left from the downward conveying unit 126.

Moreover, the bundling unit 121 has an outboard discharge unit 128 below the bundling unit 127. The outboard discharge unit 128 is capable of accumulating a plurality of small banknote bundles produced by the bundling unit 127, and has a configuration that can be pulled out. The outboard discharge unit 128 can be pulled out from the front of the bundling unit 121. That is, the outboard discharge unit 128 receives the small banknote bundle from the bundling unit 127 in the state of being pushed into the bundling unit 121. Thereafter, the outboard discharge unit 128 is pulled out from the front surface of the bundling unit 121 to enable the small banknote bundle to be taken out of the device.

In the paper sheet processing device 1 of the third embodiment, the leftward extension part 21c of the in-base unit conveyance constituent unit 21 of the base unit 2 is connected to the coupling conveyance constituent unit 27A of the in-sorting-accumulating unit conveyance constituent unit 27 of the first consecutively connected sorting-accumulating unit 3 from the right, which is adjacent to the base unit 2. The coupling conveyance constituent unit 27A of the first sorting-accumulating unit 3 from the right is connected to the coupling conveyance constituent unit 27A of the in-sorting-accumulating unit conveyance constituent unit 27 of the second consecutively connected sorting-accumulating unit 3 from the right, which is adjacent to this sorting-accumulating unit 3. The coupling conveyance constituent unit 27A of this second sorting-accumulating unit 3 from the right is connected to the coupling conveyance constituent unit 27A of the in-sorting-accumulating unit conveyance constituent unit 27 of the third consecutively connected sorting-accumulating unit 3 from the right, which is adjacent to this sorting-accumulating unit 3.

The coupling conveyance constituent unit 27A of the third sorting-accumulating unit 3 from the right is connected to the coupling conveyance constituent unit 122A of the in-bundling unit conveyance constituent unit 122 of the first consecutively connected bundling unit 121 from the right, which is adjacent to this sorting-accumulating unit 3. The coupling conveyance constituent unit 122A of this first bundling unit 121 from the right is connected to the coupling conveyance constituent unit 122A of the in-bundling unit conveyance constituent unit 122 of the second consecutively connected bundling unit 121 from the right, which is adjacent to this bundling unit 121.

The in-base unit conveyance constituent unit 21 of the base unit 2, the in-sorting-accumulating unit conveyance constituent unit 27 of each of the three sorting-accumulating units 3, and the in-bundling unit conveyance constituent unit 122 of each of the two bundling units 121 constitute the conveyance unit 30 of the paper sheet processing device 1 of the third embodiment.

Here, for example, a look will be taken at the first sorting-accumulating unit 3 from the right and the second sorting-accumulating unit 3 from the right. In this case, the first sorting-accumulating unit 3 from the right is a processing unit that has one in-sorting-accumulating unit conveyance constituent unit 27 that constitutes the conveyance unit 30 and post-count accumulating parts 14, and the second sorting-accumulating unit 3 from the right is another processing unit that has another in-sorting-accumulating unit conveyance constituent unit 27 that constitutes the conveyance unit 30. The first sorting-accumulating unit 3 from the right and the second sorting-accumulating unit 3 from the right are consecutively connected to the base unit 2. In this case, the one in-sorting-accumulating unit conveyance constituent unit 27 of the first sorting-accumulating unit 3 from the right connects the in-base unit conveyance constituent unit 21 provided in the adjacent base unit 2 and the other in-sorting-accumulating unit conveyance constituent unit 27 provided in the second consecutively connected sorting-accumulating unit 3 from the right, which is adjacent to the side opposite to that of the base unit 2.

For example, a look will be taken at the second sorting-accumulating unit 3 from the right and the third sorting-accumulating unit 3 from the right. In this case, the second sorting-accumulating unit 3 from the right is a processing unit that has one in-sorting-accumulating unit conveyance constituent unit 27 that constitutes the conveyance unit 30 and post-count accumulating parts 14, and the third sorting-accumulating unit 3 from the right is another processing unit that has another in-sorting-accumulating unit conveyance constituent unit 27 that constitutes the conveyance unit 30. The second sorting-accumulating unit 3 from the right and the third sorting-accumulating unit 3 from the right are consecutively connected to the base unit 2 via the first sorting-accumulating unit 3 from the right. In this case, the one in-sorting-accumulating unit conveyance constituent unit 27 of the second sorting-accumulating unit 3 from the right connects the other in-sorting-accumulating unit conveyance constituent unit 27 provided in the first consecutively connected sorting-accumulating unit 3 from the right, which is adjacent to the base unit 2 side, and the other in-sorting-accumulating unit conveyance constituent unit 27 provided in the third consecutively connected sorting-accumulating unit 3 from the right, which is adjacent to the side opposite to that of the base unit 2.

For example, a look will be taken at the third sorting-accumulating unit 3 from the right and the first bundling unit 121 from the right. In this case, the third sorting-accumulating unit 3 from the right is a processing unit that has one in-sorting-accumulating unit conveyance constituent unit 27 that constitutes the conveyance unit 30 and post-count accumulating parts 14, and the first bundling unit 121 is another processing unit that has another in-bundling unit conveyance constituent unit 122 that constitutes the conveyance unit 30. The third sorting-accumulating unit 3 from the right and the first bundling unit 121 from the right are consecutively connected to the base unit 2 via the first and second sorting-accumulating units 3 from the right. In this case, the one in-sorting-accumulating unit conveyance constituent unit 27 of the third sorting-accumulating unit 3 from the right connects the other in-sorting-accumulating unit conveyance constituent unit 27 provided in the second consecutively connected sorting-accumulating unit 3 from the right, which is adjacent to the base unit 2 side, and the in-bundling unit conveyance constituent unit 122 provided in the first consecutively connected bundling unit 121 from the right, which is adjacent to the side opposite to that of the base unit 2.

According to the paper sheet processing device 1 of the third embodiment, the coupling conveyance constituent unit 27A and the branching conveyance constituent unit 27B can be driven independently of each other in relation to all the sorting-accumulating units 3. Therefore, for example, in the first sorting-accumulating unit 3 from the right, even if the branching conveyance constituent unit 27B is rendered undriveable due to the occurrence of a drive motor abnormality, paper sheets S can be conveyed from the base unit 2 to the second sorting-accumulating unit 3 from the right by the coupling conveyance constituent unit 27A. As a result, a sorting process similar to that of the first embodiment can be performed by the base unit 2 and the second sorting-accumulating unit 3 from the right.

Further, for example, during one sorting process by the base unit 2 and the first sorting-accumulating unit 3 from the right, even if conveying of paper sheets S becomes impossible due to jamming or the like occurring in the branching conveyance constituent unit 27B of the first sorting-accumulating unit 3 from the right, it is possible to convey the paper sheets S from the base unit 2 to the second sorting-accumulating unit 3 from the right by the coupling conveyance constituent unit 27A of the first sorting-accumulating unit 3 from the right. As a result, it is possible to continue the one sorting process with the base unit 2 and the second sorting-accumulating unit 3 from the right. It is also possible to perform the same sorting process as the first embodiment with the base unit 2 and the third sorting-accumulating unit 3 from the right.

Further, with respect to all the sorting-accumulating units 3, the coupling conveyance constituent unit 27A and the branching conveyance constituent unit 27B can be driven independently. Therefore, for example, when performing the bundling process with at least either one of the two bundling units 121, the paper sheets S can be conveyed by driving only the coupling conveyance constituent unit 27A, with the branching conveyance constituent unit 27B of each of the sorting-accumulating units 3 not being driven. Therefore, power consumption can be reduced and noise can be reduced.

The coupling conveyance constituent unit 27A and the branching conveyance constituent unit 27B each have separate drive motors, and the coupling conveyance constituent unit 122A and the branching conveyance constituent unit 122B each have separate drive motors. Therefore, the load on each drive motor can be reduced. As a result, the power transmission components have high durability, and noise can be suppressed.

Note that these effects can be obtained by adopting the following configuration. That is, the drive power of one drive motor is transmitted to the coupling conveyance constituent unit 27A and the branching conveyance constituent unit 27B by switching a clutch. The coupling conveyance constituent unit 27A and the branching conveyance constituent unit 27B can be driven independently. The drive power of one drive motor is transmitted to the coupling conveyance constituent unit 122A and the branching conveyance constituent unit 122B by switching the clutch. The coupling conveyance constituent unit 122A and the branching conveyance constituent unit 122B can be driven independently.

Further, the coupling conveyance constituent unit 27A and the branching conveyance constituent unit 27B each have separate drive motors, and the coupling conveyance constituent unit 122A and the branching conveyance constituent unit 122B each have separate drive motors. For this reason, each drive unit can be separated and unit exchange becomes easy.

### SUPPLEMENTARY NOTES

A paper sheet processing device according to an embodiment of the present invention includes: a receiving part which opens to an exterior of the device, in which paper sheets from the exterior of the device are set, and which dispenses the set paper sheets in a stacked state, one by one; a conveyance unit which conveys the paper sheets dispensed from the receiving part; an identification unit which identifies whether the paper sheets that are being conveyed by the conveyance unit are a to-be-counted paper sheet or a reject paper sheet, and which counts a paper sheet identified as the to-be-counted paper sheet; a post-count accumulating part which accumulates the counted paper sheet; and a plurality of reject accumulating parts which accumulate, in a state sorted by reason for rejection, a paper sheet identified as the reject paper sheet.

The paper sheet processing device described above includes a plurality of reject accumulating parts which accumulate, in a state sorted by reason for rejection, the paper sheet identified as the reject paper sheet by the identification unit. For this reason, it is possible to sort the paper sheet identified as the reject paper sheet by reason for rejection. Therefore, it is possible to improve the efficiency of subsequent processing performed on the paper sheet identified as a reject paper sheet.

In the above paper sheet processing device, the plurality of reject accumulating parts may include a reject provisional accumulating part and a reject final accumulating part. The paper sheet processing device may further includes: a control unit which accumulates, in the reject provisional accumulating part, a paper sheet that has a possibility of being accumulated in the post-count accumulating part by re-identified by the identification unit, the control unit accumulating, in the reject final accumulating part, a paper sheet that has no possibility of being accumulated in the post-count accumulating part even if re-identified by the identification unit.

According to the above paper sheet processing device, among the paper sheets identified as a reject paper sheet, a paper sheet that has a possibility of being accumulated in the post-count accumulating part by being re-identified by the identification unit is accumulated in the reject provisional accumulating part. Among the paper sheets identified as reject paper sheets, a paper sheet that has no possibility of being accumulated in the post-count accumulating part even if re-identified by the identification unit is accumulated in the reject final accumulating part. For this reason, if only the paper sheets accumulated in the reject provisional accumulating part are re-identified by the identification unit, the paper sheets identified as a to-be-counted paper sheet by this re-identification can be accumulated in the post-count accumulating part. Therefore, the time required for the re-identification process can be shortened as compared to the case where all the paper sheets identified as a reject sheet are re-identified.

In the above paper sheet processing device, the plurality of reject accumulating parts may include a reject provisional accumulating part and a reject final accumulating part. The paper sheet processing device further includes: a control unit which accumulates, in the reject provisional accumulating part, a paper sheet that has a possibility of being identified as the to-be-counted paper sheet by re-identification by the identification unit, the control unit accumulating, in the reject final accumulating part, a paper sheet that has no possibility of being identified as the to-be-counted paper sheet by re-identification by the identification unit.

In the above paper sheet processing device, in a case where a paper sheet exists in the reject provisional accumulating part, the control unit may execute a notification that urges the paper sheet accumulated in the reject provisional accumulating part to be set in the receiving part.

According to the above paper sheet processing device, when a paper sheet exists in the reject provisional accumulating part, a notification is executed that urges the paper sheet accumulated in the reject provisional accumulating part to be set in the receiving part. For this reason, the notification allows the operator to re-insert the paper sheet accumulated in the reject provisional accumulating part into the receiving part.

In the above paper sheet processing device, the reject provisional accumulating part may be configured to dispense paper sheets accumulated therein one by one. The conveyance unit may include a return conveyance unit which conveys, to the identification unit, the paper sheets dispensed from the reject provisional accumulating part.

According to the above paper sheet processing device, among the paper sheets identified as a reject paper sheet, the reject provisional accumulating part, which accumulates paper sheets that have a possibility of being accumulated in the post-count accumulating part by being re-identified by the identification unit, dispenses the paper sheets one by one, and the return conveyance unit conveys the paper sheets to the identification unit. For this reason, the paper sheets of the reject provisional accumulating part can be automatically re-identified.

In the above paper sheet processing device, the control unit may cause the return conveyance unit to convey the paper sheets accumulated in the reject provisional accumulating part to the identification unit until there are no longer any paper sheets accumulated in the reject provisional accumulating part.

According to the above paper sheet processing device, the paper sheets accumulated in the reject provisional accumulating part are automatically conveyed to the identification unit by the return conveyance unit until there are no longer any paper sheets accumulated in the reject provisional accumulating part. For this reason, since a return operation of the paper sheets by a manual operation of the operator becomes unnecessary, it becomes possible to perform banknote processing more efficiently.

In the above paper sheet processing device, the receiving part and the identification unit may be aligned in a lateral direction. The receiving part may be configured to be capable to being pulled out from a device main body in the lateral direction to an opposite side of the identification unit. The identification unit and the conveyance unit may be opened in a state in which the receiving part is pulled out in the lateral direction from the device main body.

According to the above paper sheet processing device, the identification unit and the conveyance unit can be opened by pulling out the receiving part to the side opposite the identification unit in the lateral direction from the device main body. Thereby, removal of jammed paper sheets is easy.

The above paper sheet processing device may further include: a base unit which comprises an in-base unit conveyance constituent unit, the receiving part, the identification unit, and the reject accumulating part, the in-base unit conveyance constituent unit constituting the conveyance unit; a first processing unit which comprises a first in-processing unit conveyance constituent unit and the post-count accumulating part, the first in-processing unit conveyance constituent unit constituting the conveyance unit; and a second processing unit which comprises a second in-processing unit conveyance constituent unit which constitutes the conveyance unit. The first processing unit may be adjacent to the second processing unit, and placed between the base unit and the second processing unit. The first in-processing unit conveyance constituent unit may include: a coupling conveyance constituent unit which connects the in-base unit conveyance constituent unit and the second in-processing unit conveyance constituent unit; and a branching conveyance constituent unit which branches from the coupling conveyance constituent unit and is connected to the post-count accumulating part. The coupling conveyance constituent unit and the branching conveyance constituent unit may be independently driven.

According to the above paper sheet processing device, the coupling conveyance constituent unit and the branching conveyance constituent unit of the first processing unit can be independently driven. For this reason, for example, when conveying paper sheets from the in-base unit conveyance constituent unit of the base unit to the second in-processing unit conveyance constituent unit provided in the second processing unit adjacent to the side of the first processing unit opposite to that of the base unit via the coupling conveyance constituent unit of the first processing unit, if the branching conveyance constituent unit connected to the post-count accumulating part of the first processing unit is not driven, it is possible to reduce power consumption. Even if the branching conveyance constituent unit of the first processing unit is in an undriveable state, it is possible to convey paper sheets from the base unit or another processing unit on the base unit side to the second processing unit via the coupling conveyance constituent unit of the first processing unit.

In the above paper sheet processing device, the first processing unit may be adjacent to the base unit.

The above paper sheet processing device may further include: a third processing unit which is adjacent to the base unit and comprises a third in-processing unit conveyance constituent unit which constitutes the conveyance unit. The first processing unit may be placed between the second processing unit and the third processing unit. The coupling conveyance constituent unit may connect the in-base unit conveyance constituent unit and the second in-processing unit conveyance constituent unit via the third in-processing unit conveyance constituent unit.

The present invention may be applied to a paper sheet processing device.

What is claimed is:

1. A paper sheet processing device comprising:
a receiving part which opens to an exterior of the device, in which paper sheets from the exterior of the device are set, and which dispenses the set paper sheets in a stacked state, one by one;
a conveyance unit which conveys the paper sheets dispensed from the receiving part;
an identification unit which identifies whether the paper sheets that are being conveyed by the conveyance unit are a to-be-counted paper sheet or a reject paper sheet;
a post-count accumulating part which accumulates a paper sheet identified as the to-be-counted paper sheet the counted paper sheet; and
a plurality of reject accumulating parts which accumulate, in a state sorted by reason for rejection, a paper sheet identified as the reject paper sheet and a reject provisional accumulating part and a reject final accumulating part; and
a control unit which accumulates, in the reject provisional accumulating part, a paper sheet that has a possibility of being accumulated in the post-count accumulating part by re-identified by the identification unit,
the control unit accumulating, in the reject final accumulating part, a paper sheet that has no possibility of being accumulated in the post-count accumulating part even if re-identified by the identification unit.

2. The paper sheet processing device according to claim 1, wherein the control unit accumulates, in the reject provisional accumulating part, a paper sheet that is being conveyed by the conveyance unit and has been identified as having a conveyance abnormality.

3. The paper sheet processing device according to claim 1,
wherein the control unit accumulates, in the reject provisional accumulating part, a paper sheet that has a possibility of being identified as the to-be-counted paper sheet by re-identification by the identification unit, and
the control unit accumulates, in the reject final accumulating part, a paper sheet that has no possibility of being identified as the to-be-counted paper sheet by re-identification by the identification unit.

4. The paper sheet processing device according to claim 1, wherein, in a case where a paper sheet exists in the reject provisional accumulating part, the control unit executes a notification that urges the paper sheet accumulated in the reject provisional accumulating part to be set in the receiving part.

5. The paper sheet processing device according to claim 1,
wherein the reject provisional accumulating part is configured to dispense paper sheets accumulated therein one by one, and
the conveyance unit comprises a return conveyance unit which conveys, to the identification unit, the paper sheets dispensed from the reject provisional accumulating part.

6. The paper sheet processing device according to claim 5, wherein the control unit causes the return conveyance unit to convey the paper sheets accumulated in the reject provisional accumulating part to the identification unit until there are no longer any paper sheets accumulated in the reject provisional accumulating part.

7. The paper sheet processing device according to claim 1,
wherein the receiving part and the identification unit are aligned in a lateral direction,
the receiving part is configured to be capable to being pulled out from a device main body in the lateral direction to an opposite side of the identification unit, and
the identification unit and the conveyance unit are opened in a state in which the receiving part is pulled out in the lateral direction from the device main body.

8. The paper sheet processing device according to claim 1, further comprising:
a base unit which comprises an in-base unit conveyance constituent unit, the receiving part, the identification unit, and the reject accumulating part, the in-base unit conveyance constituent unit constituting the conveyance unit;
a first processing unit which comprises a first in-processing unit conveyance constituent unit and the post-count accumulating part, the first in-processing unit conveyance constituent unit constituting the conveyance unit; and
a second processing unit which comprises a second in-processing unit conveyance constituent unit which constitutes the conveyance unit,
wherein the first processing unit is adjacent to the second processing unit, and placed between the base unit and the second processing unit,
the first in-processing unit conveyance constituent unit comprises:
a coupling conveyance constituent unit which connects the in-base unit conveyance constituent unit and the second in-processing unit conveyance constituent unit; and
a branching conveyance constituent unit which branches from the coupling conveyance constituent unit and is connected to the post-count accumulating part, and
the coupling conveyance constituent unit and the branching conveyance constituent unit are independently driven.

9. The paper sheet processing device according to claim 8, wherein the first processing unit is adjacent to the base unit.

10. The paper sheet processing device according to claim 8, further comprising:
a third processing unit which is adjacent to the base unit and comprises a third in-processing unit conveyance constituent unit which constitutes the conveyance unit,
wherein the first processing unit is placed between the second processing unit and the third processing unit, and
the coupling conveyance constituent unit connects the in-base unit conveyance constituent unit and the second in-processing unit conveyance constituent unit via the third in-processing unit conveyance constituent unit.
